(19) United States
(12) Patent Application Publication
(10) Pub. No.: US 2025/0222439 A1
(43) Pub. Date: Jul. 10, 2025

(54) IN-SITU CRYSTALLIZED ULTRA-LOW ZEOLITE CONTENT FLUID CATALYTIC CRACKING CATALYST

(71) Applicant: BASF Corporation, Florham Park, NJ (US)

(72) Inventors: Junmei WEI, Iselin, NJ (US); Lucas DORAZIO, Iselin, NJ (US); Samantha L. RICE, East Brunswick, NJ (US); Nicholas Robert FAVATE, Iselin, NJ (US); David J. CAMEROTA, Attapulgus, GA (US); Karl C. KHARAS, Dublin, OH (US)

(21) Appl. No.: 18/701,796

(22) PCT Filed: Oct. 20, 2022
(86) PCT No.: PCT/US2022/047329

§ 371 Date: Apr. 16, 2024

Related U.S. Application Data
(60) Provisional application No. 63/270,464, filed on Oct. 21, 2021.

(51) Int. Cl. B01J 29/08; B01J 35/61; B01J 37/00; B01J 37/04; B01J 37/08; B01J 37/30; C01B 39/24; C10G 11/05

(52) U.S. Cl. CPC B01J 29/088; B01J 35/615; B01J 37/0045; B01J 37/04; B01J 37/08; B01J 37/30; C01B 39/24; C10G 11/05; B01J 2229/183; B01J 2229/36; B01J 2229/66; C01P 2002/60; C01P 2004/03; C01P 2006/12; C10G 2400/02; C10G 2400/20

(57) ABSTRACT

Disclosed herein is a fluid catalytic cracking catalyst comprising an in-situ crystallized zeolite material and a matrix material. In at least one embodiment, the deactivated catalyst has a ratio of zeolite surface area to matrix surface area (Z/M) of less than about 1, and a unit cell size of at least about 24.3 Å.

### CROSS-REFERENCE TO RELATED APPLICATION(S)

This application claims the benefit of priority of U.S. Provisional Patent Application No. 63/270,464, filed on Oct. 21, 2021, the disclosure of which is hereby incorporated by reference herein in its entirety.

### FIELD OF THE DISCLOSURE

The present disclosure relates to petroleum refining catalysts and compositions thereof. In particular, the present disclosure relates to fluid catalytic cracking (FCC) catalysts and compositions thereof, methods of their preparation, and methods of their use.

### BACKGROUND OF THE DISCLOSURE

Fluid Catalytic Cracking (FCC) processes aim to catalytically break (crack) large organic molecules into smaller, more useful compounds. Zeolite-containing materials have been used for decades to catalyze FCC processes.

Practically, the ultimate efficiency of an FCC process is often limited by waste byproduct production, e.g. coke. Decreasing waste byproduct production per mass of useful product provides great economic advantages in terms of reactor active time, value of product produced between maintenance, conversion of feed, etc. There is a need to develop FCC catalyst components exhibiting lower coke formation per amount of feed cracked than those currently available.

### SUMMARY OF THE DISCLOSURE

The present disclosure provides a fluid catalytic cracking (FCC) catalyst component that includes an in-situ crystallized zeolite on alumina particles, wherein the deactivated (e.g., steamed) FCC catalyst component has a ratio of zeolite surface area (ZSA) to matrix surface area (MSA) of less than about 1.

Various zeolite may be crystallized on the pure alumina particles, such as, without limitation, zeolites with the structure BEA, MSE, -SVR, FAU, MOR, CON, SOF, MFI, IMF, FER, MWW, MTT, TON, EUO, MRE, NAT, CHA, EMT, or a mixture of two or more thereof. In certain embodiments, the zeolite may be selected from zeolite X, Y-zeolite, ZSM-5, beta zeolite, ZSM-11, ZSM-14, ZSM-17, ZSM-18, ZSM-20, ZSM-31, ZSM-34, ZSM-41, ZSM-46, mordenite, chabazite, or mixtures of two or more thereof. In one embodiment, the zeolite is zeolite Y. In certain embodiments, e.g., when the zeolite is zeolite Y, the fresh catalytic zeolite may have a unit cell size of at least about 24.50 Å; the deactivated (e.g., steamed) catalyst may have a unit cell size of at least about 24.3 Å.

In at least one embodiment, alumina microspheres may include one or more of alumina derived from boehmite, alumina derived from pseudo boehmite, alumina derived from flash calcined gibbsite, boehmite, pseudo boehmite, flash calcined gibbsite, calcined flash calcined gibbsite, silica-doped alumina, gamma-alumina (including gamma-aluminas A or B), aluminas C or D, χ-alumina, δ-alumina, θ-alumina, κ-alumina, α-alumina, rare earth-modified variations thereof, alkaline earth metal-modified variations thereof, bismuth-modified variations thereof, or a mixture of two or more thereof.

In one embodiment, the alumina microspheres may be made by first milling alumina particles (e.g., dry milling such as, without limitations, chop milling, hammer milling, or ball milling), slurrying the milled alumina particles, and spray drying the milled and slurried alumina to make alumina microspheres having a suitable average particle size. Milled alumina for spray drying may have a particle size in the range of 2-10 μm.

In certain embodiments, the alumina and/or the zeolite may be modified by a non-alumina constituent selected from a rare earth element, bismuth, an alkaline earth element, or a mixture of two or more thereof. Suitable rare earth elements may include ytterbium, gadolinium, cerium, lanthanum, or a mixture of two or more thereof. Suitable alkaline earth elements may include barium, strontium, calcium, magnesium, or a mixture of two or more thereof.

In certain embodiments, the present disclosure provides a method for preparing any of the FCC catalyst components described herein. The method includes crystallizing, in-situ, a zeolite on alumina microspheres, wherein the deactivated FCC catalyst component has a ratio of ZSA to MSA of less than about 1, and a unit cell size of at least about 24.3 Å. The zeolite may be any of the zeolites described herein. The alumina may be any of the alumina described herein.

In certain embodiments, crystallizing includes mixing alumina-containing microspheres with an aluminum source, a silicon source, optionally sodium hydroxide, and water to form an alkaline slurry. In certain embodiments, crystallizing further includes heating the alkaline slurry to a temperature, and for a time, sufficient to crystallize the desired amount of zeolite, forming zeolitic microspheres.

In certain embodiments, the method includes, prior to crystallizing, forming the alumina microspheres, e.g., by milling an alumina particle precursor, slurrying the milled alumina particle precursor, and spray drying the slurried and milled alumina particle precursor to form alumina microspheres of a suitable size as described herein.

In certain embodiments, the method for preparing any of the FCC catalyst components further includes modifying the zeolitic microspheres (after crystallization) and/or the alumina particles (before crystallization) with a non-alumina constituent selected from a rare earth element, bismuth, an alkaline earth element, or a mixture of two or more thereof. Suitable rare earth elements may include ytterbium, gadolinium, cerium, lanthanum, or a mixture of two or more thereof. Suitable alkaline earth elements may include barium, strontium, calcium, magnesium, or a mixture of two or more thereof. In one embodiment, modifying may include impregnating the zeolitic microspheres and/or the alumina particles with a precursor of the selected non-alumina constituent (e.g., cerium nitrate, cerium acetate, lanthanum nitrate, lanthanum acetate).

In certain embodiments, the present disclosure provides a method of cracking a hydrocarbon feed by contacting the feed with an FCC catalyst component according to any of the embodiments described herein or with an FCC catalyst composition according to any of the embodiments described herein. The methods of the instant disclosure may result in one or more of: enhanced feed conversion, enhanced bottoms cracking, improved bottoms-coke selectivity, or reduced coke production.

### Definitions

As used herein, the singular forms “a,” “an,” and “the” include plural references unless the context clearly indicates otherwise. Thus, for example, reference to “a microsphere” includes a single microsphere as well as a mixture of two or more microspheres, and the like.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. In certain embodiments, the term “about” includes the recited number±10%, such that “about 10” would include from 9 to 11.

As used herein, the term “catalyst” or “catalyst composition” or “catalyst material” or “catalyst component” refers to a material that promotes a reaction. As used herein, the term “composition,” when referring to an FCC catalyst composition or an FCC additive composition, refers to a blend or a mixture of two or more separate and distinct components, such as a first component mixed or blended with a second component. In certain embodiments, the components in the composition are chemically combined and cannot be separated through physical means (e.g., filtration). In other embodiments, the components in the composition are not chemically combined and may be separated through physical means (e.g., filtration).

As used herein, the term “fluid catalytic cracking” or “FCC” refers to a conversion process in petroleum refineries wherein high-boiling, high-molecular weight hydrocarbon fractions of petroleum crude oils are converted to more valuable gasoline, olefinic gases, and other products.

“Cracking conditions” or “FCC conditions” refers to typical FCC process conditions. Typical FCC processes are conducted at reaction temperatures of 450° to 650° C. with catalyst regeneration temperatures of 600° to 850° C. Hot regenerated catalyst is added to a hydrocarbon feed at the base of a riser reactor. The fluidization of the solid catalyst particles may be promoted with a lift gas. The catalyst vaporizes and superheats the feed to the desired cracking temperature. During the upward passage of the catalyst and feed, the feed is cracked, and coke deposits on the catalyst. The coked catalyst and the cracked products exit the riser and enter a solid-gas separation system, e.g., a series of cyclones, at the top of the reactor vessel. The cracked products are fractionated into a series of products, including gas, gasoline, light gas oil, and heavy cycle gas oil. Some heavier hydrocarbons may be recycled to the reactor.

As used herein, the term “feed” or “feedstock” refers to that portion of crude oil that has a high boiling point and a high molecular weight. In FCC processes, a hydrocarbon feedstock is injected into the riser section of an FCC unit, where the feedstock is cracked into lighter, more valuable products upon contacting hot catalyst circulated to the riser-reactor from a catalyst regenerator.

As used herein, microspheres can be obtained by spray drying. As is understood by skilled artisans, microspheres are not necessarily perfectly spherical in shape. The various catalyst components described herein may be particles in the form of microspheres.

As used herein, the terms “matrix” or “non-zeolitic matrix” refer to the constituents of an FCC catalyst component that are not zeolites or molecular sieves.

As used herein, the term “zeolite” refers to a crystalline aluminosilicate with a framework based on an extensive three-dimensional network of silicon, aluminum and oxygen ions and have a substantially uniform pore distribution.

As used herein, the term “intergrown zeolite” refers to a zeolite that is formed by an in-situ crystallization process.

As used herein, the term “in-situ crystallized” refers to the process in which a zeolite is grown or intergrown directly on/in a microsphere and is intimately associated with the matrix or non-zeolitic material, for example, as described in U.S. Pat. Nos. 4,493,902 and 6,656,347. The zeolite is intergrown directly on/in the macropores of the precursor microsphere such that the zeolite is intimately associated is uniformly dispersed on the matrix or non-zeolitic material.

As used herein, the terms “preformed microspheres” or “precursor microspheres” refer to microspheres obtained by spray drying and calcining a non-zeolitic component.

As used herein, the term “zeolite-containing microsphere” refers to a microsphere obtained by in-situ crystallizing a zeolite material on pre-formed precursor.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

### BRIEF DESCRIPTION OF THE DRAWINGS

Embodiments of the present disclosure are illustrated by way of example, and not by way of limitation, in the figures of the accompanying drawings.

FIG. 1 presents measured performance data of scaled-up catalyst samples according to an embodiment and a reference material, as measured by a circulate riser unit.

FIG. 2 shows SEM images of a catalyst according to an embodiment and a reference material.

### DETAILED DESCRIPTION

This disclosure is directed in certain embodiments to a fluid catalytic cracking (FCC) catalyst component that includes an in-situ crystallized zeolite on alumina-containing microspheres, wherein the FCC catalyst component has a ratio of zeolite surface area (ZSA) to matrix surface area (MSA), also may be referred to herein as Z/M ratio, of less than about 1.8. In certain embodiments, the Z/M ratio of the FCC catalyst component may be less than about 1.7, less than about 1.6, less than about 1.5, less than about 1.3, or less than about 1. In certain embodiments, the Z/M ratio may vary from any of about 0.7, about 0.9, or about 1.1 to any of about 1.5, about 1.6, about 1.7, or about 1.8, or any sub-range or single Z/M value therein. In one embodiment, the Z/M ratio of the FCC catalyst component ranges from about 0.9 about 1.8. It is believed, without being construed as limiting, that the amount of feed converted to useful products per production of coke is a function of Z/M ratio. Specifically, it is believed that larger molecules (e.g., molecules comprising the feedstock) are cracked into somewhat smaller products by interactions with the matrix material (e.g., gamma alumina), and these intermediate products are converted to final products (e.g., light cycle oil, heavy cycle oil, gasoline, etc.) by interactions with the zeolite material. Increased the available matrix surface area (i.e., decreasing Z/M) allows more feed to be cracked while producing to same amount of coke, or reduces the amount of coke produced while cracking a given amount of feed. It is additionally thought that high unit cell size promotes low-coke feed cracking.

In certain embodiments, the steam-deactivated Z/M ratio (sZ/M ratio), after the FCC catalyst component has been subjected to steaming conditions (e.g., 800° C. for, e.g., about 1-24 hours, at 100% steam), is less than about 1.0. In certain embodiments, the sZ/M ratio may be less than about 0.9, less than about 0.8, or less than about 0.7. In certain embodiments, the sZ/M ratio may range from any of about 0.2, about 0.25, or about 0.3 to any of about 0.4, about 0.5, about 0.6, about 0.7, about 0.8, about 0.9, or about 1.0, or any sub-range or single sZ/M value therein. In one embodiment, the sZ/M ratio of the FCC catalyst component ranges from about 0.2 to about 0.7. In one embodiment, the sZ/M ratio of the FCC catalyst component ranges from about 0.25 to about 0.6. In one embodiment, the sZ/M ratio of the FCC catalyst component ranges from about 0.3 to about 0.5.

To arrive at the Z/M ratio (or the sZ/M ratio), the total surface area (TSA) of the FCC catalyst component is obtained following the BET method and the matrix surface area (MSA) of the FCC catalyst component is obtained following the t-plot method. The difference between TSA and MSA is the zeolite surface area (ZSA) of the FCC catalyst component.

In certain embodiments, the BET TSA of the FCC catalyst component ranges from any of about 50 m²/g, about 75 m²/g, about 100 m²/g, or about 125 m²/g to any of about 150 m²/g, about 175 m²/g, about 200 m²/g, about 250 m²/g, about 275 m²/g, about 300 m²/g, about 350 m²/g, about 400 m²/g, about 450 m²/g, or about 500 m²/g, or any sub-range or single BET TSA value therein. In one embodiment, the BET TSA of the FCC catalyst component ranges from about 100 m²/g to about 300 m²/g. In one embodiment, the BET TSA of the FCC catalyst component ranges from about 125 m²/g to about 270 m²/g. In one embodiment, the BET TSA of the FCC catalyst component ranges from about 185 m²/g to about 250 m²/g.

In certain embodiments, the t-plot MSA of the FCC catalyst component ranges from any of about 25 m²/g, about 50 m²/g, about 75 m²/g, or about 90 m²/g to any of about 110 m²/g, about 125 m²/g, about 130 m²/g, about 140 m²/g, about 150 m²/g, about 160 m²/g, about 170 m²/g, about 175 m²/g, about 180 m²/g, or about 190 m²/g, or any sub-range or single t-plot MSA value therein. In one embodiment, the t-plot MSA of the FCC catalyst component ranges from about 25 m²/g to about 175 m²/g. In one embodiment, the t-plot MSA of the FCC catalyst component ranges from about 50 m²/g to about 150 m²/g. In one embodiment, the t-plot MSA of the FCC catalyst component ranges from about 65 m²/g to about 130 m²/g.

In certain embodiments, the ZSA of the FCC catalyst component ranges from any of about 25 m²/g, about 50 m²/g, about 75 m²/g, or about 90 m²/g to any of about 110 m²/g, about 125 m²/g, about 130 m²/g, about 140 m²/g, about 150 m²/g, about 160 m²/g, about 170 m²/g, about 175 m²/g, about 180 m²/g, or about 190 m²/g, or any sub-range or single ZSA value therein. In one embodiment, the ZSA of the FCC catalyst component ranges from about 25 m²/g to about 175 m²/g. In one embodiment, the ZSA of the FCC catalyst component ranges from about 50 m²/g to about 150 m²/g. In one embodiment, the ZSA of the FCC catalyst component ranges from about 110 m²/g to about 145 m²/g.

FCC catalyst components, according to embodiments described herein, may include a variety of zeolites, such as, without limitations, zeolites selected from zeolites with the structure BEA, MSE, -SVR, FAU, MOR, CON, SOF, MFI, IMF, FER, MWW, MTT, TON, EUO, MRE, NAT, CHA, EMT, or a mixture of two or more thereof. In certain embodiments, the zeolite is selected from zeolite X, Y-zeolite, ZSM-5, beta zeolite, ZSM-11, ZSM-14, ZSM-17, ZSM-18, ZSM-20, ZSM-31, ZSM-34, ZSM-41, ZSM-46, mordenite, chabazite, or mixtures of two or more thereof. In one embodiment, the zeolite is zeolite Y.

In some embodiments, the zeolite has a unit cell parameter of from about 24.10 Å to about 24.80 Å. In some embodiments, the zeolite has a unit cell parameter of from about 24.30 Å to about 24.75 Å. In some embodiments, the zeolite has a unit cell parameter of from about 24.50 Å to about 24.70 Å. In some embodiments, the zeolite has a unit cell parameter of from about 24.50 Å to about 24.80 Å. Without being construed as limiting, it is believed that a relatively large effective unit cell size results in more liquefied petroleum gas (LPG). LPG has also been increasingly of greater interest in the FCC market.

In some embodiments, the zeolite has a unit cell parameter of from about 24.30 Å to about 24.75 Å. In some embodiments, the zeolite has a unit cell parameter of from about 24.30 Å to about 24.74 Å. In some embodiments, the zeolite has a unit cell parameter of from about 24.30 Å to about 24.73 Å. In some embodiments, the zeolite has a unit cell parameter of from about 24.30 Å to about 24.72 Å. In some embodiments, the zeolite has a unit cell parameter of from about 24.30 Å to about 24.71 Å. In some embodiments, the zeolite has a unit cell parameter of from about 24.50 Å to about 24.75 Å. In some embodiments, the zeolite has a unit cell parameter of from about 24.50 Å to about 24.74 Å. In some embodiments, the zeolite has a unit cell parameter of from about 24.50 Å to about 24.73 Å. In some embodiments, the zeolite has a unit cell parameter of from about 24.50 Å to about 24.72 Å. In some embodiments, the zeolite has a unit cell parameter of from about 24.50 Å to about 24.71 Å. In some embodiments, the zeolite has a unit cell parameter of from about 24.60 Å to about 24.75 Å. In some embodiments, the zeolite has a unit cell parameter of from about 24.60 Å to about 24.74 Å. In some embodiments, the zeolite has a unit cell parameter of from about 24.60 Å to about 24.73 Å. In some embodiments, the zeolite has a unit cell parameter of from about 24.60 Å to about 24.72 Å. In some embodiments, the zeolite has a unit cell parameter of from about 24.60 Å to about 24.71 Å. In some embodiments, the zeolite has a unit cell parameter of from about 24.65 Å to about 24.75 Å. In some embodiments, the zeolite has a unit cell parameter of from about 24.65 Å to about 24.74 Å. In some embodiments, the zeolite has a unit cell parameter of from about 24.65 Å to about 24.73 Å. In some embodiments, the zeolite has a unit cell parameter of from about 24.65 Å to about 24.72 Å. In some embodiments, the zeolite has a unit cell parameter of from about 24.65 Å to about 24.71 Å. In some embodiments, the zeolite has a unit cell parameter of from about 24.45 Å to about 24.75 Å. In some embodiments, the zeolite has a unit cell parameter of from about 24.45 Å to about 24.74 Å. In some embodiments, the zeolite has a unit cell parameter of from about 24.45 Å to about 24.73 Å. In some embodiments, the zeolite has a unit cell parameter of from about 24.45 Å to about 24.72 Å. In some embodiments, the zeolite has a unit cell parameter of from about 24.45 Å to about 24.71 Å. In some embodiments, the zeolite has a unit cell parameter of about 24.10 Å, 24.11 Å, 24.12 Å, 24.13 Å, 24.14 Å, 24.15 Å, 24.16 Å, 24.17 Å, 24.18 Å, 24.19 Å, 24.20 Å, 24.21 Å, 24.22 Å, 24.23 Å, 24.24 Å, 24.25 Å, 24.26 Å, 24.27 Å, 24.28 Å, 24.29 Å, 24.30 Å, 24.31 Å, 24.32 Å, 24.33 Å, 24.34 Å, 24.35 Å, 24.36 Å, 24.37 Å, 24.38 Å, 24.39 Å, 24.40 Å, 24.41 Å, 24.42 Å, 24.43 Å, 24.44 Å, 24.45 Å, 24.46 Å, 24.47 Å, 24.48 Å, 24.49 Å, 24.50 Å, 24.51 Å, 24.52 Å, 24.53 Å, 24.54 Å, 24.55 Å, 24.56 Å, 24.57 Å, 24.58 Å, 24.59 Å, 24.60 Å, 24.61 Å, 24.62 Å, 24.63 Å, 24.64 Å, 24.65 Å, 24.66 Å, 24.67 Å, 24.68 Å, 24.69 Å, 24.70 Å, 24.71 Å, 24.72 Å, 24.73 Å, 24.74 Å, 24.75 Å, 24.76 Å, 24.77 Å, 24.78 Å, 24.79 Å, or 24.80 Å.

The above unit cell sizes may be particularly suitable for zeolites having FAU zeolite structure, such as zeolite Y. As understood by those skilled in the art, some of the zeolite structures described hereinabove may have different unit cell dimensions from those recited herein.

The alumina-containing microspheres in the FCC catalyst components contemplated herein may include one or more of alumina derived from boehmite, alumina derived from pseudo boehmite, alumina derived from flash calcined gibbsite, boehmite, pseudo boehmite, flash calcined gibbsite, calcined flash calcined gibbsite, silica-doped alumina, gamma-alumina (including gamma-aluminas A or B), aluminas C or D, χ-alumina, δ-alumina, θ-alumina, κ-alumina, α-alumina, rare earth-modified variations thereof, alkaline earth metal-modified variations thereof, bismuth-modified variations thereof, or a mixture of two or more thereof. In certain embodiments, the alumina particles include one or more of alumina derived from boehmite, alumina derived from pseudo boehmite, alumina derived from flash calcined gibbsite, flash calcined gibbsite, calcined flash calcined gibbsite, gamma-alumina, rare earth-modified variations thereof, alkaline earth metal-modified variations thereof, or a mixture of two or more thereof. In one embodiment, the alumina particles comprise lanthanum doped gamma alumina derived from calcination of boehmite and/or pseudo boehmite and modified with a lanthanum precursor. In one embodiment, the alumina particles comprise calcined flash calcined gibbsite that may include chi alumina, an alumina that is similar to gamma-alumina, or a combination thereof. In one embodiment, the alumina particles include a gamma-alumina and peptized boehmite.

As used herein, “flash calcined gibbsite,” refers to gibbsite that has been passed through a hot column, e.g., at a temperature of about 500° C. and 800° C., to form a mixture of steam and a substantially anhydrous alumina, wherein said substantially anhydrous alumina is referred to as flash calcined gibbsite. The term “calcined flash calcined gibbsite,” refers to flash calcined gibbsite that has been subjected to further calcination, e.g., at about 700° C. to about 900° C., or about 750° C. to about 850° C., or about 800° C.

In certain embodiments, one or more of the above-recited alumina form the entirety of the non-zeolitic matrix of the FCC catalyst component. In one embodiment, the FCC catalyst component is free or substantially free (i.e., has less than about 15 wt. %, less than about 12 wt. %, less than about 10 wt. %, less than about 8 wt. %, less than about 5 wt. %, less than about 3 wt. %, less than about 1 wt. %, or 0 wt. %, based on total weight of the FCC catalyst component) of clay. Without being construed as limiting, it is believed that an alumina matrix (i.e., a non-zeolitic matrix that includes one or more of the above recited pure alumina particles) is better than a clay matrix at coke minimization.

There are several theories as to the reasons that a clay matrix may be inferior to an alumina-based matrix at coke minimization.

One reason may be, without being construed as limiting, that spinel has a relatively high levels of strong Lewis acid sites, which may bind tightly to hydrocarbon fragments. The hydrocarbons that do not desorb and get to the regenerator are coke. The pure alumina matrix may, in certain embodiments, may have a strong Lewis acid site density of less than about 70 μmol/g, less than about 65 μmol/g, less than about 60 μmol/g, less than about 55 μmol/g, less than about 50 μmol/g, less than about 45 μmol/g, less than about 40 μmol/g, or any sub-range or single Lewis acid density value therein.

The pure alumina microspheres may have an average particle size of about 40 μm to about 150 μm, about 60 μm to about 120 μm, or about 70 μm to about 90 μm. In one embodiment, the pure alumina particles undergo one or more of: milling (e.g., dry milling such as, without limitations, chop milling, hammer milling, or ball milling to D90 of 5-10 μm alumina particles), slurrying, and/or spray drying to arrive at an average particle size of about 40 μm to about 150 μm, about 60 μm to about 120 μm, or about 70 μm to about 90 μm.

In some embodiments, the alumina is present in the FCC catalyst component in an amount ranging from any of about 50 wt. %, about 55 wt. %, about 60 wt. %, about 65 wt. %, about 70 wt. %, or about 75 wt. % to any of about 80 wt. %, about 85 wt. %, about 90 wt. %, or about 95 wt. %, or any sub-range or single concentration value therein, based on the total weight of the FCC catalyst component.

Any of the pure alumina and/or the zeolites in the FCC catalyst components described herein may be further modified by a non-alumina constituent such as, without limitations, from a rare earth element, bismuth, an alkaline earth element, oxides thereof, or a mixture of two or more thereof. In some embodiments, the non-alumina constituent is present in the FCC catalyst component in an amount ranging from any of about 0.1 wt. %, about 0.5 wt. %, about 1 wt. %, about 2 wt. %, about 3 wt. %, about 4 wt. %, or about 5 wt. % to any of about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, or about 18 wt. %, or any sub-range or single concentration value therein, based on the total weight of the FCC catalyst component. In certain embodiments, the non-alumina constituent is present in the FCC catalyst component in an amount ranging from about 0.1 wt. % to about 18 wt. %, from about 3 wt. % to about 18 wt. %, from about 5 wt. % to about 18 wt. %, or from about 10 wt. % to about 17 wt. %, or any sub-range or single concentration values therein, based on the total weight of the FCC catalyst component.

In one embodiment, the alumina and/or the zeolites in the FCC catalyst components described herein are modified with a rare earth element. Suitable rare earth elements include, without limitations, ytterbium, gadolinium, cerium, lanthanum, or a mixture of two or more thereof. In one embodiment, the alumina particles and/or the zeolites in the FCC catalyst components described herein are modified with cerium, e.g., from about 0.1 wt. % to about 15 wt. %, from about 3 wt. % to about 15 wt. %, from about 5 wt. % to about 15 wt. %, or from about 10 wt. % to about 15 wt. % cerium, based on the total weight of the FCC catalyst component. In one embodiment, the pure alumina particles and/or the zeolites in the FCC catalyst components described herein are modified with lanthanum, e.g., from about 0.1 wt. % to about 18 wt. %, from about 1 wt. % to about 18 wt. %, from about 5 wt. % to about 18 wt. %, or from about 10 wt. % to about 17 wt. % lanthanum oxide, based on the total weight of the FCC catalyst component. In one embodiment, the alumina particles and/or the zeolites in the FCC catalyst components described herein are modified with lanthanum and cerium.

In certain embodiments, modifying the alumina matrix with lanthanum may beneficially promote bottoms conversion to light cycle oil (LCO) and may contribute to the enhanced LCO yield exhibited by the FCC catalyst components contemplated herein.

In one embodiment, the alumina and/or the zeolites in the FCC catalyst components described herein are modified with an alkaline earth element. Suitable alkaline earth element include, without limitations, barium, strontium, calcium, magnesium, or a mixture of two or more thereof. In one embodiment, the alumina particles and/or the zeolites in the FCC catalyst components described herein are modified with strontium.

In certain embodiments, this disclosure is directed to a method for preparing any of the FCC catalyst components described herein by crystallizing, in-situ, a zeolite on alumina microspheres, wherein the FCC catalyst component has a Z/M ratio of less than about 1.3. In certain embodiments, the Z/M ratio may be less than about 1.2, less than about 1.1, less than about 1.0, less than about 0.9, less than about 0.8, or less than about 0.7. In certain embodiments, the Z/M ratio may range from any of about 0.2, about 0.3, about 0.4, about 0.5, or about 0.6 to any of about 0.7, about 0.8, about 0.9, about 1.0, about 1.1, about 1.2, or about 1.3, or any sub-range or single Z/M value therein. Any of the zeolites described hereinbefore may be crystallized on any of the alumina microspheres described hereinbefore.

In certain embodiments, the method for preparing any of the FCC catalyst components may further include, prior to crystallizing, preparation of the alumina-containing microspheres. In one embodiment, preparing the alumina microspheres includes milling an alumina precursor (e.g., a precipitated alumina made from boehmite or from pseudo boehmite), making a slurry of the milled alumina precursor and optionally sodium silicate sol, and spray drying the slurried and milled alumina precursor with optional sodium silicate sol to arrive at an average particle size of about 40 μm to about 150 μm, about 60 μm to about 120 μm, or about 70 μm to about 90 μm.

In certain embodiments, preparing the alumina microspheres may further include modifying the alumina with one or more of rare earth element, bismuth, or alkaline earth element. In one embodiment, preparing the alumina microspheres includes modifying the pure alumina with a rare earth element. Suitable rare earth elements include, without limitations, ytterbium, gadolinium, cerium, lanthanum, or a mixture of two or more thereof. In one embodiment, preparing the alumina microspheres includes modifying the alumina with cerium. Modifying the alumina with cerium may include impregnating the alumina with a cerium precursor, such as cerium nitrate or cerium acetate. In one embodiment, preparing the alumina microspheres includes modifying the alumina with lanthanum. Modifying the alumina with lanthanum may include impregnating the alumina with a lanthanum precursor, such as lanthanum nitrate or lanthanum acetate.

In certain embodiments, preparing the alumina microspheres may further include modifying the alumina with an alkaline earth element. Suitable alkaline earth element include, without limitations, barium, strontium, calcium, magnesium, or a mixture of two or more thereof. In one embodiment, preparing the alumina microspheres includes modifying alumina with strontium. Modifying alumina with strontium may include impregnating alumina with a strontium precursor, such as strontium nitrate or strontium acetate.

In certain embodiments, preparing the alumina microspheres may further include calcining the alumina microspheres (e.g., at about 700° C. to about 900° C., or about 750° C. to about 850° C., or about 800° C.).

For the crystallization step in the method of preparing the FCC catalyst components described herein, any of the alumina-containing microspheres described herein may be mixed with an aluminum source, a silicon source, water, and optionally sodium hydroxide to obtain an alkaline slurry. Seeds (such as those described in U.S. Pat. No. 4,631,262, the teachings of which are incorporated by reference in their entirety) may also be added to said slurry. Thereafter, the alkaline slurry may be heated to a temperature, and for a time, sufficient to crystallize the desired wt. % zeolite to form zeolitic microspheres. The phase composition of the zeolite (e.g., zeolite Y) may range from any of about 5 wt. %, about 6 wt. %, about 7 wt. %, or about 8 wt. % to any of about 15 wt. %, about 17 wt. %, about 20 wt. %, about 25 wt. %, or about 30 wt. %, or any sub-range or single phase composition therein, based on total weight of the FCC catalyst component.

Suitable sacrificial aluminum sources for the zeolite crystallization may include, without limitations, metakaolin, sodium aluminate, or a combination thereof.

In certain embodiments, the method for preparing the FCC catalyst components described herein also includes preparation of sacrificial aluminum source particles. In one embodiment, the aluminum source particles are derived from calcining kaolinite at a temperature, and for a duration, sufficient to transform the kaolinite to metakaolin without forming spinel. In one embodiment, the aluminum source is metakaolin.

Although kaolinite (and the resulting metakaolin) includes aluminum and silicon at an atomic ratio of Si/Al of 1.0, the metakaolin by itself may provide insufficient amount of silicon to crystallize certain zeolites with a Si/Al ratio greater than 1.0. For instance, zeolite Y has an atomic ratio of Si/Al of 2.5 and would necessitate a secondary silicon source, in addition to metakaolin, to facilitate zeolite Y growth.

Suitable sacrificial silicon sources for the zeolite crystallization may include, without limitations, sodium silicate, quartz, silica gel, silica sol, sodium silicate sol, and a combination thereof. In one embodiment, the silicon source used includes sodium silicate sol (e.g., mostly water containing sodium silicate which may be made by dissolving solid sodium silicate in water). In one embodiment, the silicon source used includes silica gel. In one embodiment, the silicon source used includes quartz.

When sodium silicate sol is used as the sacrificial silicon source for Y-zeolite crystallization, it may be added all at once at the beginning of the zeolite crystallization or zeolite growth reaction. Other sacrificial silicon sources, such as, without limitations, silica gel or quartz, do not bring sodium into the zeolite crystallization reaction and may be used to give more flexibility in tuning the amount of sodium and silica present in zeolite crystallization, since the two constituents (sodium and silica) can be separately added. In contrast, sodium silicate (or sodium silicate sols) already include sodium therein, which provides less flexibility in tuning the amount of sodium and silica present during zeolite crystallization. This may pose some challenges or result in added process steps because the sodium to silica ratio in sodium silicates (or sodium silicate sols) may be high, which may contribute to rapid zeolite growth. A rapid zeolite growth may be less favorable due to its potential adverse effect on the hydrothermal stability of the crystallized zeolite and/or due to its contribution to the growth of less favorable zeolite phase (such as GIS or GME zeolite structures).

After the crystallization step in the method of preparing the FCC catalyst components described herein, in certain embodiments, the method further includes isolating or separating the zeolitic microspheres from the alkaline slurry. Isolating or separating the zeolitic microspheres may be carried out by commonly used methods such as filtration. In certain embodiments, the zeolitic microspheres may be washed or contacted with water or other suitable liquid to remove residual crystallization liquor.

In certain embodiments, the method of preparing the FCC catalyst components described herein further includes ion-exchanging the zeolite (e.g., ion-exchanging the Y-zeolite) to reduce sodium content in said FCC catalyst component and/or to replace the sodium ions with other more favorable ions. For instance, in one embodiment, the Y zeolite is ion-exchanged to reduce the sodium content of the FCC catalyst component to less than about 0.7 wt. %, less than about 0.5 wt. %, or less than about 0.3 wt. % Na₂O, based on the total weight of the FCC catalyst component. Ion-exchanging may be conducted once, twice, three times, four times, five times, six times, or as many times as needed to arrive at a target sodium content.

In certain embodiments, the sodium ions may be replaced by other ions, for instance, by ion-exchanging ammonium cations, rare earth metals, or a combination thereof, to arrive at an FCC catalyst component that includes a zeolite that is modified with more favorable cations.

In some embodiments, the method may further include mixing the zeolitic microspheric material with an ammonium nitrate solution prior to or subsequent to contacting zeolite in the sodium form prior to the mixing with the ammonium nitrate solution. In some embodiments, the mixing with the ammonium nitrate solution is conducted at acidic pH conditions. In some embodiments, the mixing with the ammonium nitrate solution is conducted at pH of about 3 to about 3.5. In some embodiments, the mixing with the ammonium nitrate solution is conducted at a temperature above room temperature. In some embodiments, the mixing with the ammonium nitrate solution is conducted at a temperature of at least about 80° C. to about 100° C., including increments therein. In certain embodiments, ion-exchanging the zeolitic microspheric material with ammonium cations reduces the sodium content of the zeolitic microspheric material to from about 1 wt. % Na₂O to about 2 wt. % Na₂O, based on total weight of the FCC catalyst component.

In some embodiments, the ammonium exchanged microspheric material is further ion exchanged with a rare earth ion solution. In some embodiments, the rare earth ion are nitrates of ytterbium, neodymium, samarium, gadolinium, cerium, lanthanum, or a mixture of any two or more such nitrates. In some embodiments, the rare earth ions are derived from the lanthanides or yttrium. In some embodiments, the microspheres are contacted with solutions of lanthanum nitrate or yttrium nitrate. In particular embodiments, the microspheres are contacted with solutions of lanthanum nitrate. Rare earth levels in the range of about 5 wt. % to about 18 wt. %, about 10 wt. % to about 17 wt. %, or about 10 wt. % to about 15 wt. %, based on the total weight of the FCC catalyst component, are contemplated. In certain embodiments, the amount of rare earth added to the catalyst as a rare earth oxide will range from about 1 wt. % to about 5 wt. %, or from about 2 wt. % to about 3 wt. % rare earth oxide (REO), based on the total weight of the FCC catalyst component. In one embodiment, the FCC catalyst component includes lanthana at a concentration ranging from about 5 wt. % to about 18 wt. %, about 10 wt. % to about 17 wt. %, or about 10 wt. % to about 15 wt. %, based on the total weight of the FCC catalyst component.

Lanthana content of the catalyst material can be estimated by chemical analysis (e.g., ICP chemical analysis). For fresh (i.e., not yet steamed) FCC catalyst material disclosed herein, substantially all lanthana (i.e., 100% within experimental error) is found within the zeolitic material.

In certain embodiments, the method further includes calcining the zeolitic microspheres. The calcination may be conducted for at least about two hours. In certain embodiments, the calcining is conducted at a temperature of from about 500° C. to about 750° C. In certain embodiments, the calcination may be conducted in the presence of about 25% v/v steam.

In certain embodiments, after calcination, the FCC catalyst component may be subjected to an additional ammonium nitrate solution ion exchange to further reduce the sodium content in the FCC catalyst component. In one or more embodiments, the ion exchange step or steps are carried out so that the resulting FCC catalyst component contains less than about 0.2 wt. % Na₂O (e.g., about 0.02 wt. % Na₂O to about 0.2 wt. % Na₂O), based on the total weight of the FCC catalyst component. After ion exchange, the microspheres may be calcined again (e.g., at a temperature of about 500° C. to about 750° C.).

In certain embodiments, the method of preparing the FCC catalyst components described herein further includes steam-treating the FCC catalyst component. In some embodiments, the steam-treating is conducted at a temperature of at least about 700° C. (e.g., about 750° C. or about 800° C.). In some embodiments, the steam-treating is conducted for at least about four hours. In some embodiments, the steam-treating is conducted for about one to about 24 hours.

Crystal size and the distribution of zeolite material in FCC catalysts varies considerably depending on method of making, materials, etc. The FCC catalyst material of this disclosure was analyzed for crystal size using scanning electron microscope (SEM).

Zeolite crystal size of the catalyst disclosed herein can also be characterized by SEM. Crystal size as measured by SEM ranges from 1000 Å to 3000 Å. SEM measurement yields a number-weighted average crystal size.

SEM analysis of the zeolitic catalyst material disclosed herein also demonstrates another distinguishing feature: the presence of isolated crystals, with few to no intergrown crystals. It is believed, without being bound by theory, that isolated crystals grown on matrix material allow greater access by feedstock to matrix surface than in the case of highly intergrown catalytic materials. It is believed that alumina matrix material facilitates the cracking of large molecules in feed, and increasing the available matrix surface area contributes to lower coke/higher conversion of the catalytic material disclosed herein.

### Method of Use

In certain aspects, the instant disclosure is directed to a method of cracking a hydrocarbon feed by contacting said feed with any of the FCC catalyst components contemplated by the instant disclosure (e.g., those that include a zeolite crystallized in-situ on alumina particles and have a Z/M ratio of deactivated catalyst of about 1.0 or less) or with any of the FCC catalyst compositions described herein.

In certain embodiments, the methods of cracking a hydrocarbon feed, as described herein, result in improved bottoms upgrading performance. It is believed that forming the non-zeolitic matrix of the FCC catalyst component from alumina, rather than a traditional clay matrix, improve bottoms conversion. As such, in certain embodiments, the methods described herein result in a bottoms yield that is lower than the bottoms yield resulting from contacting the hydrocarbon feed with a FCC catalyst component that includes a non-zeolitic matrix that includes clay instead of at least part of alumina (while otherwise being the same aside from the non-zeolitic matrix material).

In certain embodiments, the methods of cracking a hydrocarbon feed, as described herein, result in a reduced coke yield. It is believed that forming the non-zeolitic matrix of the FCC catalyst component from alumina particles, rather than a traditional clay matrix, yields less coke. As such, in certain embodiments, the methods described herein result in a coke yield that is lower than the coke yield resulting from contacting the hydrocarbon feed with a FCC catalyst component that includes a non-zeolitic matrix that includes clay instead of at least part of the pure alumina (while otherwise being the same aside from the non-zeolitic matrix material).

In certain embodiments, the methods of cracking a hydrocarbon feed, as described herein, result in enhanced light cycle oil (LCO) yield. For instance, it is believed that LCO yield if a function of the Z/M ratio and that for a given matrix technology, as the Z/M decreases, the LCO yield increases. As such, in certain embodiments, the methods described herein result in a LCO yield that is greater than the LCO yield resulting from contacting the hydrocarbon feed with a FCC catalyst component that has a Z/M ratio of steam-deactivated catalyst of about 1.0 or higher (while otherwise being the same aside from the Z/M ratio).

In certain embodiments, the methods of cracking a hydrocarbon feed, as described herein, result in enhanced liquefied petroleum gas (LPG) yield. For instance, it is believed that relatively large effective unit cell parameters result in increased LPG yield. As such, in certain embodiments, the methods described herein result in a LPG yield that is greater than the LPG yield resulting from contacting the hydrocarbon feed with a FCC catalyst component that has a unit cell size that is below 24.3 Å (while otherwise being the same aside from the unit cell size dimensions).

### ILLUSTRATIVE EXAMPLES

The following examples are set forth to assist in understanding the disclosure and should not be construed as specifically limiting the invention described and claimed herein. Such variations of the invention, including the substitution of all equivalents now known or later developed, which would be within the purview of those skilled in the art, and changes in formulation or minor changes in experimental design, are to be considered to fall within the scope of the invention incorporated herein.

### Example 1: In-Situ Crystallization of Y-Zeolite on Rare Earth-Doped Gamma Alumina a Microspheres

Y zeolite was crystallized in-situ on microspheres of primarily alumina, which alumina was rare earth-doped gamma alumina A. 4 wt. % rare-earth doped gamma alumina A was milled to D90 of about 5 μm. 94 parts of milled gamma alumina A in the form of a 40% solid slurry was mixed with 6 parts SiO₂ in the form of sodium silicate solution. The mixture was spray dried into microspheres having an average particle size of about 80 μm. The microspheres were calcined at 1500° F. for 2 hours.

The alumina microspheres were combined with sodium silicate solution, zeolite-Y seeds, water, and sacrificial metakaolin microspheres. The metakaolin microspheres were prepared by calcining spray-dried kaolin clay microspheres to a temperature and for a time sufficient to transform kaolin to metakaolin, but insufficient to transform to spinel. The mixture was added to a reactor, and heated to a temperature of 190° F. for crystallization. The crystallization temperature was maintained with stirring for 10-14 hours. Resultant zeolitic microspheres were then filtered and washed to produce sodium-ion form Y-zeolite FCC catalyst (NaY form).

The zeolitic microspheres were then subjected to ion exchange to replace sodium ions with lanthanum ions. The ion-exchanged microspheres were then steamed at 1450° F. for 24 hours. The resultant catalyst was designated “Catalyst A”. Characterization of certain properties of Catalyst A was carried out at the NaY stage, after ion exchange, and after steam deactivation. Properties of catalyst A are shown in Table 1 below.

### Example 2: In-Situ Crystallization of Y-Zeolite on Gamma Alumina B

Y zeolite was crystallized in-situ on microspheres spray dried using gamma alumina B without rare earth dopant. Gamma alumina B was milled to D90 of about 5 μm. 94 parts of milled gamma alumina B in the form of a 40% solid slurry was mixed with 6 parts SiO₂ in the form of sodium silicate solution. The mixture was spray dried into microspheres having an average particle size of about 80 μm. The microspheres were calcined at 1500° F. for 2 hours.

The alumina microspheres were combined with sodium silicate solution, zeolite-Y seeds, water, caustic, and sacrificial metakaolin microspheres. The metakaolin microspheres were prepared by calcining spray-dried kaolin clay microspheres to a temperature and for a time sufficient to transform kaolin to metakaolin, but insufficient to transform to spinel. The mixture was added to a reactor, and heated to a temperature of 190° F. for crystallization. The crystallization temperature was maintained with stirring for 10-14 hours. Resultant zeolitic microspheres were then filtered and washed to produce sodium-ion form Y-zeolite FCC catalyst (NaY form).

The zeolitic microspheres were then subjected to ion exchange to replace sodium ions with lanthanum ions. The ion-exchanged microspheres were then steamed at 1450° F. for 24 hours. The resultant catalyst was designated “Catalyst B”. Characterization of certain properties of Catalyst B was carried out at the NaY stage, after ion exchange, and after steam deactivation. Properties of catalyst B are shown in Table 1 below.

Catalyst B was also scaled up using 15 Kg of microsphere B in a 25 Gallon crystallization reactor. Sample was subjected to the same ion exchange and steaming process. Properties of this sample are summarized in Table 2 below.

### Example 3: In-Situ Crystallization of Y-Zeolite on Alumina C and Clay Particles

Y zeolite was crystallized in-situ on microspheres of primarily alumina, which alumina was alumina C. Alumina C was milled to D90 of about 5 μm. 83 parts of milled alumina C in the form of a 40% solid slurry was mixed with 11 parts hydrous kaolin in the form of about a 60% solid slurry and 6 parts SiO₂ in the form of sodium silicate solution. The mixture was spray dried into microspheres having an average particle size of about 80 μm. The microspheres were calcined at 1500° F. for 2 hours.

The alumina and clay microspheres were combined with sodium silicate solution, zeolite-Y seeds, water, and caustic. The mixture was added to a reactor, and heated to a temperature of 190° F. for crystallization. The crystallization temperature was maintained with stirring for 10-14 hours. Resultant zeolitic microspheres were then filtered and washed to produce sodium-ion form Y-zeolite FCC catalyst (NaY form).

The zeolitic microspheres were then subjected to ion exchange to replace sodium ions with lanthanum ions. The ion-exchanged microspheres were then steamed at 1450° F. for 24 hours. The resultant catalyst was designated “Catalyst C”. Characterization of certain properties of Catalyst C was carried out at the NaY stage, after ion exchange, and after steam deactivation. Properties of catalyst C are shown in Table 1 below.

Catalyst C was also scaled up using 15 Kg of microsphere C in a 25 Gallon crystallization reactor. Sample was subjected to the same ion exchange and steaming process. Properties of this sample are summarized in Table 2 below

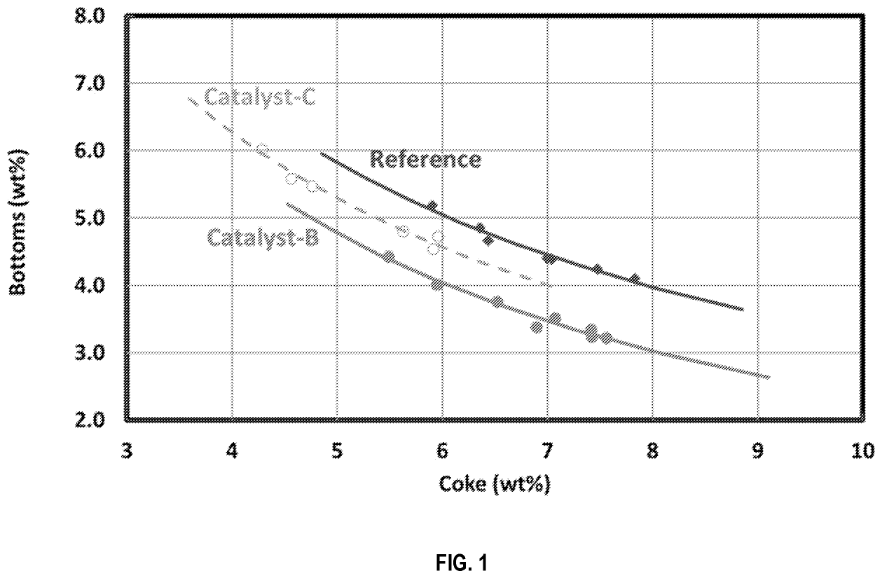

Table 2, Table 3, and FIG. 1 include data from a reference catalyst. Reference is a commercially available product. Reference microspheres were spray dried using 25% hydrous clay, 25% clay calcined at 2300° F., and 50% alumina-A. Zeolitic material was then crystallized in-situ, and ion exchange was performed according to conventional methods.

Table 1 presents a comparison between properties of the example catalyst A, B, and C. surface area presented are in m²/g, Unit Cell Size (UCS) in Å, and compositions in wt. %. Table 2 presents comparisons between properties of scaled-up samples and a reference material, presented in the same units as Table 1.

TABLE 1
Properties of example catalysts

| | | |
|---|---|---|
| Catalyst A | Catalyst B | Catalyst C |

NaY

| | | | |
|---|---|---|---|
| Total surface area | 301 | 296 | 192 |
| matrix surface area | 141 | 116 | 64 |
| zeolite surface area | 160 | 180 | 128 |
| HgPV (40-20K) ml/g | 0.4421 | 0.3580 | 24.681 |
| UCS | 24.688 | 24.632 | 0.299 |

finished product

| | | | |
|---|---|---|---|
| Total surface area | 250 | 241 | 175 |
| matrix surface area | 129 | 109 | 72 |
| zeolite surface area | 121 | 132 | 103 |
| % Na2O | 0.10 | 0.13 | 0.17 |
| % La2O3 | 3.37 | 2.15 | 1.99 |

Steamed 1450 F./24 h

| | | | |
|---|---|---|---|
| Total surface area | 174 | 158 | 108 |
| matrix surface area | 118 | 101 | 60 |
| zeolite surface area | 56 | 57 | 48 |
| SZSA/SMSA | 0.47 | 0.56 | 0.80 |
| SUCS | 24.382 | 24.375 | 24.397 |

TABLE 2
Properties of scale up samples

| | | Catalyst B- | Catalyst C- |
|---|---|---|---|
| | Reference | Scale up | Scale up |
| | NaY | | |
| Total surface area | | 287 | 193 |
| matrix surface area | | 112 | 63 |
| zeolite surface area | | 175 | 130 |
| HgPV (40-20K) ml/g | | 0.3680 | 0.2960 |
| UCS | | 24.631 | 24.675 |

Finished product

| | | | |
|---|---|---|---|
| Total surface area | 329 | 243 | 171 |
| matrix surface area | 139 | 121 | 73 |
| zeolite surface area | 190 | 122 | 95 |
| % Na2O | 0.14 | 0.12 | 0.15 |
| % La2O3 | 2.59 | 2.61 | 2.27 |

Steamed 1450 F./24 h

| | | | |
|---|---|---|---|
| Total surface area | 184 | 167 | 114 |
| matrix surface area | 78 | 112 | 62 |
| zeolite surface area | 106 | 57 | 52 |
| SZSA/SMSA | 1.36 | 0.51 | 0.84 |
| SUCS | 24.317 | 24.420 | 24.402 |

FIG. 1 presents measured performance data of scaled-up Catalyst B, scaled-up Catalyst C, and the reference material, as measured by a circulate riser unit (CRU). As shown in FIG. 1, at a given coke generation, Catalysts B and C convert more feed (bottoms) to product than the reference material. At a given level of bottoms conversion, Catalysts B and C produce less coke that the reference material. CRU testing was performed after steaming. For Catalyst B compared to the reference material, coke selectivity improved by 22% at constant bottoms conversion and bottoms upgrading was improved by 20% at constant coke. For Catalyst C compared to the reference material, coke selectivity improved by 11% at constant bottoms conversion and bottoms upgrading was improved by 8% at constant coke.

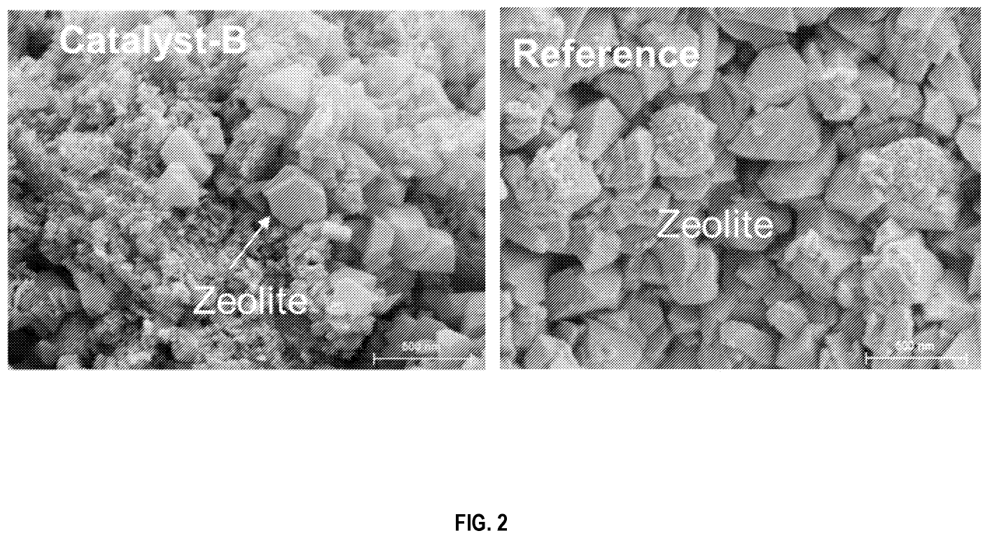

FIG. 2 shows SEM images of Catalyst B and the reference material (the scalebars are 500 nm). In catalyst B, zeolite crystals have grown on matrix material, and there is free matrix material clearly visible between zeolite crystals. The reference catalyst has a high degree of crystal intergrowth, rather than the well dispersed crystals of Catalyst B. The crystals of Catalyst B are also smaller than those of the reference material.

Table 3 shows the amount of various products produced in a fluid catalytic cracking process for Catalyst B, Catalyst C, and reference material. The test was performed at 80% gasoline conversion. Catalyst B demonstrate improved LPG, Gasoline yield, LCO (light cycle oil), LOC/HCO (light cycle oil/heavy cycle oil) ratio, and coke selectivity compared to the reference catalyst.

TABLE 3
catalytic selectivity at 80% gasoline conversion

| | Catalyst-B | Catalyst-C | reference |
|---|---|---|---|
| C3 Olefinicity | 0.87 | 0.87 | 0.88 |
| C4 Olefinicity | 0.64 | 0.63 | 0.65 |
| Total C4 = s (%) | 7.44 | 7.51 | 7.82 |
| iC4=/iC4 | 0.55 | 0.52 | 0.64 |
| LPG (%) | 18.30 | 18.90 | 18.70 |
| C5+ GASOLINE (%) | 56.20 | 55.70 | 54.70 |
| LCO (%) | 12.90 | 12.30 | 12.50 |
| HCO (%) | 4.10 | 4.70 | 4.50 |
| LCO/HCO | 3.13 | 2.64 | 2.76 |
| COKE (%) | 5.87 | 5.83 | 6.87 |

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment.

The present disclosure has been described with reference to specific exemplary embodiments thereof. The specification and drawings are, accordingly, to be regarded in an illustrative rather than a restrictive sense. Various modifications of the disclosure in addition to those shown and described herein will become apparent to those skilled in the art and are intended to fall within the scope of the appended claims.

1. A fluid catalytic cracking catalyst comprising:
an in-situ crystallized zeolite material and a matrix material, wherein the deactivated catalyst has a ratio of zeolite surface area to matrix surface area (Z/M) of less than about 1 and a unit cell size of deactivated catalyst at least about 24.3 Å.

2. The catalyst of claim 1, wherein the zeolitic material further comprises a rare earth element.

3. The catalyst of claim 2, wherein the rare earth element is present as a rare earth oxide in an amount of about 10 wt. % to 17 wt. % on zeolite.

4. The catalyst of claim 3, wherein the rare earth element comprises lanthanum.

5. The catalyst of claim 4, wherein substantially all the lanthanum comprising the catalyst is in the zeolitic material.

6. The catalyst of claim 1, wherein the zeolitic material consists essentially of Y-zeolite.

7. The catalyst of claim 1, wherein the zeolitic material contains substantially separate crystals, and is substantially free of intergrown crystals.

8. The catalyst of claim 1, wherein the zeolitic material is crystallized on particles comprising at least about 70 wt % pure alumina.

9. The catalyst of claim 8, wherein the pure alumina consists of at least one of alumina A, alumina B, alumina C, or alumina D.

10. A fluid catalytic cracking catalyst comprising:
an in-situ crystallized zeolite material and a matrix material, wherein the catalyst has a zeolite content of less than about 30 wt. % without zeolite intergrowth.

11. The catalyst of claim 10, wherein the crystal size measured by SEM is about 1000-3000 Å.

12. A method of making a fluid catalytic cracking catalyst comprising a zeolitic material, the method comprising:
preforming precursor microspheres comprising alumina, with less than 20% clay; and
in-situ crystallizing a zeolite on the preformed microspheres to a weight percent of less than about 30.

13. The method of claim 12, wherein the crystallizing comprises:
mixing the preformed precursor microspheres, microspheres comprising metakaolin, sodium silicate solution, and zeolite seeds to form a slurry; and
heating the slurry to a temperature and for a time sufficient to crystallize the zeolite.

14. The method of claim 13, further comprising exchanging sodium cations in the zeolitic material for other ions, the ion-exchanged product having a weight percent of sodium oxide of less than about 0.2%.

15. The method of claim 13, further comprising deactivating the catalyst by steaming the catalyst for about 15-30 hours at about 1350-1550° F.

16. The method of claim 15, wherein a steamed ratio of zeolite surface area to matrix surface area (steamed Z/M) of the deactivated catalyst is less than about 1, and wherein a steamed unit cell size (SUCS) of the deactivated catalyst at least about 24.3 Å.

17. The method of claim 12, wherein the zeolitic material further comprises a rare earth element.

18. The method of claim 17, wherein the rare earth element is present as a rare earth oxide in an amount of about 10 wt. % to 17 wt. % on zeolite.

19. The method of claim 18, wherein the rare earth element comprises lanthanum.

20. The method of claim 19, wherein substantially all the lanthanum comprising the catalyst is in the zeolitic material.

21-42. (canceled)
